(19) United States
(12) Patent Application Publication
(10) Pub. No.: US 2013/0207787 A1
(43) Pub. Date: Aug. 15, 2013

(54) Method of Implementing and Operating and a Read/Write Unit for a System with Multiple Contactlessly Readable Transponders

(71) Applicants: Dieter HORST, Cadolzburg (DE); Jörg NEIDIG, Nurnberg (DE); Markus WEINLÄNDER, Happurg (DE)

(72) Inventors: Dieter HORST, Cadolzburg (DE); Jörg NEIDIG, Nurnberg (DE); Markus WEINLÄNDER, Happurg (DE)

(73) Assignee: Siemens Aktiengesellschaft, Muenchen (DE)

(21) Appl. No.: 13/588,567

(22) Filed: Aug. 17, 2012

(30) Foreign Application Priority Data
Aug. 19, 2011 (EP) EP11006831

(51) Int. Cl. G06K 19/073

(52) U.S. Cl. CPC G06K 19/073
USPC 340/10.51

(57) ABSTRACT

A method for implementing and operating, and a read/write unit for use in, a system that includes multiple contactlessly readable transponders each in having a unique identification number. The read/write unit is connected to an industrial control device of the system and, in a recognition phase, a first of the transponders is detected by the read/write unit. At the start of a holding phase, the identification number of the detected first transponder is stored in a holding register of the read/write unit. Then, during the holding phase, other detected transponders are ignored by the read/write unit. The identification number of the first of the detected transponders is thereafter deleted from the holding register to terminate the holding phase so that it is possible to communicate reliably with a unique transponder even over a relatively long time period without process disturbances arising from the presence of other transponders in the area of the read/write unit.

### BACKGROUND OF THE INVENTION

1. Field of the Invention

The invention relates to a read/write unit in a system that includes multiple contactlessly readable transponders, and a method for implementing and operating such a read/write unit.

2. Description of the Related Art

By using Radio Frequency Identification (RFID) technology, RFID labels, which are commonly denoted transponders or “tags”, are registered and read in a contact-free manner by read/write units (“readers”). Normally, the transponders are activated by an electromagnetic field generated by the read/write unit which emits a carrier wave with sufficient transmitted power, and are often also supplied with energy (passive transponders). Embodiments are also known in which the energy supply of the transponder is provided by a dedicated power supply, such as batteries (active transponders).

RFID technology is commonly used where objects, such as workpieces or dispatch items, are intended to be registered and unambiguously identified via radio in an environment that includes a read/write unit. For this purpose, the read/write unit is able to store information including at least one unique identification number of the transponder via radio and to re-read the information. In a working environment, i.e., in industrial automation configurations, the read/write unit is typically connected to a control unit (e.g., an industrial controller (“PLC”) or a personal computer).

In particular, when RFID technology is used in industrial production plants, it is frequently necessary to unambiguously identify exactly that object and, therefore, exactly that transponder which is located in the immediate vicinity of the read/write unit, in order to then perform, e.g., appropriate fabrication steps on the object. On the other hand, in such industrial automation settings, remote-field RFID systems, as they are known, are frequently used, which typically permit detection of transponders within an area extending for several meters around a read/write unit. In densely packed surroundings, when therefore a plurality of objects with their associated transponders are arranged in close proximity, it frequently occurs that an RFID read/write unit simultaneously detects a plurality of transponders in its acquisition range. Consequently, in addition to the transponder located closest to the read/write unit and the antenna of the read/write unit, still other transponders are detected. In this case, an unambiguous assignment of the object to be processed or to be immediately handled is no longer possible, so that errors can occur in downstream processes.

In order to solve the foregoing problem, it is known to reduce the transmitted power of the read/write unit to such an extent that, on account of the lower range associated with the reduction in transmitted power, only at most one single transponder is recognized. Here, it has proven to be disadvantageous where the transmitted power falls to such an extent or has to be reduced to such an extent that, in many cases, the desired (i.e., “correct”) transponder can no longer be reliably detected and recognized. In particular, in the cases in which, because of the process, there is a relatively long time interval between the reading and writing of data to and from the same transponder, it is not ensured that the “correct” transponder has clearly been recognized/detected at both times and that, in each case, unambiguous communication with this transponder is possible.

Another strategy for solving the foregoing problem resides in permitting the simultaneous detection and simultaneous operation of a communications relationship with a plurality of transponders in which appropriate evaluation logic is implemented by a control device to which the read/write unit is linked, with which a multiplicity of simultaneously existing communications relationships are managed and with which it is ensured that operations assigned to the “correct” (i.e., normally the closest) transponder are performed at an appropriate processing station, or the like. The disadvantage of this, however, is that the corresponding processing logic for managing the simultaneous plurality of communications relationships must be integrated into the logic of the process control system, these often also being proprietary approaches, which have to be implemented in a corresponding control device in each case matched to the particular situation.

### SUMMARY OF THE INVENTION

It is therefore an object of the present invention to provide a method for implementing and operating and a read/write unit with which, in systems or arrangements in which a multiplicity of transponders are located in the radio range of the read/write unit, unambiguous determination of a specific, closest one of the transponders is possible, where a “session” for exactly one selected one of the multiple transponders is defined by the read/write unit, so that no mutual communications relationship are established with another of the transponders during this “session”.

This and other objects and advantages are achieved in accordance with the invention by providing a method for implementing and operating a read/write unit in a configuration with multiple contactlessly readable transponders, where each of the transponders includes a unique identification number, the read/write unit is connected to an industrial control device, and, in a recognition phase, a first of the transponders is detected by the read/write unit. At the start of a holding phase, the identification number of the first transponder is stored in a holding register of the read/write unit, after which the additional or other transponders of the multiplicity are ignored by the read/write unit in the holding phase, and the identification number of the first of the transponders is deleted from the holding register to terminate the holding phase. In accordance with the method of the invention, additional transponders that are located in the receiving range of the read/write unit are prevented from disrupting a production process or the like which has already been correlated with the first transponder that has been detected.

It is also an object of the invention to provide a read/write unit for use in a configuration with multiple contactlessly readable transponders, where the read/write unit is configured to implement the above-described method. Thus, by means of the read/write unit, the same advantages can be realized as with the method of the invention.

Advantageously, during the holding phase, the transmitted power is increased to a maximum step-by-step, starting from a minimum, by the read/write unit. As a result, it is ensured that a transponder, once detected, is “held” securely even in the event of interference and movements of the transponder in the transmitting/receiving range of the read/write unit, and that contact with this transponder is not lost. This additionally has the effect that the transponder reliably remains continuously in operation and is not deactivated temporarily on account of a lack of supplied power. Likewise, in the recognition phase, starting from a low transmitted power, the transmitted power is increased gradually until at least one transponder is recognized. This ensures that the physically closest transponder will be detected with a high probability and not, accidentally, any of the others of the multiplicity of transponders that are located within the maximum transmitting/receiving radius of the read/write unit.

The holding phase is terminated by the reading unit, either following the receipt of an appropriate command from the control device or after expiration of a maximum holding period. Terminating the holding period by a command from the control device makes it possible to keep the read/write unit from making contact with other transponders until a corresponding processing step of the control device has been terminated. In particular and for reasons of safety, if therefore, for example, a termination message from the control device has been lost, it is instead or additionally possible to define a maximum holding period after which the read/write unit is again re-available to establish contact with a transponder.

In an advantageous embodiment, a blocking list relating to a number of known identification numbers is managed in the read/write unit, where in the recognition phase an identification number detected in the process is compared with the entries in the blocking list and, in the case of a positive comparison, the detected transponder is ignored. Thus, for example, objects or workpieces that are already being processed at the same processing station can be ruled out as patentially constituting a new detection, even if the transponders are located in the receiving range of the read/write unit. In addition, such double detections can be avoided.

In an advantageous embodiment, following expiration of the holding phase, the entries in the holding register can each be incorporated in the blocking list. Alternatively or in addition to this use of a blocking list, a filter or a filter instance can be installed or implemented in the read/write unit which, by using adjustable criteria, operatively determines whether a transponder detected in the recognition phase is to be ignored. To this end, for example, the identification number of the newly detected transponder can be evaluated, in which number, for example, properties of the transponder or of the object identified thereby can be encoded. Moreover, features of the radio link can also be evaluated, such as the received field strength. It is therefore possible, for example, to ignore transponders having a weak signal, which are presumably located far from the read/write unit. In another exemplary embodiment, statistics about a multiplicity of detections or communication attempts with the same transponder can be maintained, where the transponder is ignored in the event of a poor recognition rate and otherwise not. It is also contemplated to define in the filter that a transponder is accepted into the holding phase, and thus the identification number thereof is transmitted to the control device, only when there is exactly one transponder located in the receiving range of the read/write unit.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Exemplary embodiments of a method according to the invention and of a read/write unit according to the invention will be explained below by reference to the drawings, in which:

FIG. 1 is a schematic block diagram illustrating detection of identification numbers of transponders and the further processing thereof in the read/write unit in accordance with the invention; and

FIG. 2 is a flowchart of the method in accordance with an embodiment of the invention.

### DETAILED DESCRIPTION OF THE PREFERRED EMBODIMENTS

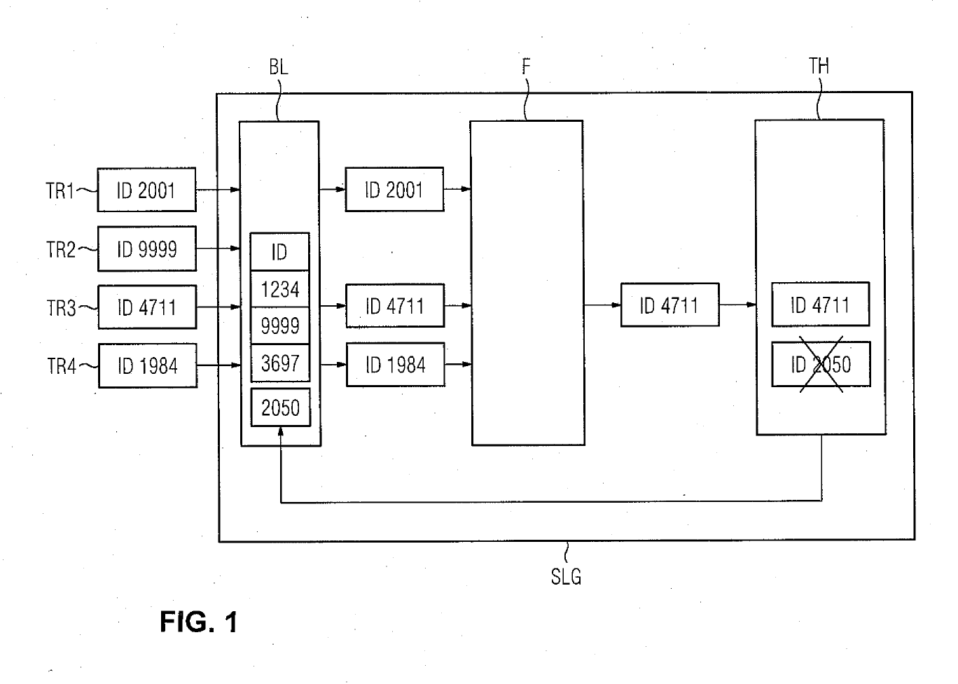

FIG. 1 is a schematic block diagram illustrating the process of detection of identification numbers of transponders and the further processing thereof in a read/write unit in accordance with the invention. In the exemplary embodiment described with respect to FIG. 1, a system or arrangement (not fully illustrated) includes a read/write unit SLG, an industrial control device (not illustrated) and four transponders TR1, . . . , TR4. The transponders TR1, . . . , TR4 are located within the maximum transmitting/receiving range of the read/write unit SLG.

Initially, the read/write unit SLG is in a recognition phase, i.e., none of the transponders TR1, . . . , TR4 are registered in the holding register TH (“Tag Hold”). The read/write unit SLG then emits a carrier wave for detection, initially with a minimum transmitted power. This transmitted power is increased gradually until at least one of the transponders TR1, . . . , TR4 is activated. In the ideal case, the transponder that is activated first is the transponder located closest to the read/write unit. In the present exemplary embodiment, the “worst case” will be assumed, in which all four transponders TR1, . . . , TR4 react. The identification numbers (ID) 2001, 9999, 7411, 1984 are then compared by the read/write unit with a blocking list BL (or “blacklist”), it being registered there that the identification numbers 1234, 9999, 3697 have already been processed by the processing station assigned to the read/write unit SLG, specifically the control device. Thus, of the four detected transponders TR1, . . . , TR4, the identification number 9999, specifically that of the transponder TR2, is already screened out and thus ignored in the further processing sequence. The identification numbers 2001, 4711, 1984 of the remaining transponders TR1, TR2 are supplied to the filter F where, by using predetermined criteria, a further selection is made. In the present illustrative embodiment, it may be determined that the identification number 4711 of the transponder TR3 that can be received best (highest RSSI value) remains available. This identification number 4711 is entered into the holding register TH. As long as this identification number 4711 is entered in the holding register TH, identifications received from the other transponders are ignored in the processing sequence. At the same time, the transmitted power of the read/write unit SLG is raised to a maximum value, to ensure that further communication with the transponder TR3 is possible without delay.

As soon as processing of an object that is marked with the transponder TR3 has been terminated by the control device, the control device reports this termination to the read/write unit, so that the corresponding identification number is deleted from the holding register TH. This is illustrated by way of example in FIG. 1 by the use of the identification number 2050, which is deleted from the holding register TH and illustrated by a cross. In accordance with an advantageous embodiment of the invention, the read/write unit automatically transfers this deleted identification number 2050 into the blocking list BL, which is illustrated in FIG. 1 by an arrow.

It is thus possible to state that, in an advantageous embodiment, during the recognition phase the transmitted power of the read/write unit SLG is initially raised step-by-step, starting from a minimum value. Consequently, as a rule, one of the transponders TR1, . . . , TR4 that is located physically closest to the antenna is generally supplied first with power. In cases in which objects do not ever come back into range of the read/write unit SLG after the processing, the blocking list BL has the effect that the intended transponders TR1, . . . , TR4 are blocked following completion of the process step, so that where these the transponders TR1, . . . , TR4 subsequently move once more undesirably into the field of the read/write unit SLG, these transponders TR1, . . . , TR4 will automatically be ignored by the read/write unit SLG. By the use of further filters F based, for example, on the radio properties of the transponders TR1, . . . , TR4 (such as the recognition rate or an RSSI value), the remaining transponders TR1, . . . , TR4 can be filtered out so that only precisely one desired transponder TR1, . . . , TR4 still remains available. If, after passing through the filter, no transponder or a plurality of transponders TR1, . . . , TR4 remain available, the read/write unit SLG triggers an error or an error message to avoid erroneous execution of downstream process steps of the control device.

During the holding phase, in an advantageous embodiment, the read/write unit stores the identification number (ID) of the transponder TR1, . . . , TR4 currently being considered. Starting from this time, the read/write unit SLG communicates exclusively with this selected, stored one of the transponders TR1, . . . , TR4. Here, all others transponders continue to be ignored. At the latest when the read/write unit SLG suddenly loses radio contact with this one of the transponders TR1, . . . , TR4, or there is a reading or write error, the read/write unit automatically increases the transmitted power, in the extreme case as high as the legally allowed maximum value. Even through using this increased transmitted power increases the risk of detecting other undesired transponders, by virtue of having registered the transponder already detected in the holding register TH, these undesired other transponders will be ignored by the read/write unit SLG.

The read/write unit SLG also continues to store the identification number in the holding register TH during operational or transmission pauses. Consequently, in the event of a re-start or of a “retry”, it is not necessary to re-seek the closest transponder. The entry stored in the holding register TH can be deleted by a command from the control unit to the read/write unit SLG, so that the method can be re-started, beginning with the recognition phase, when desired or appreciated. Optionally, the deleted identification number can be entered into the blocking list BL.

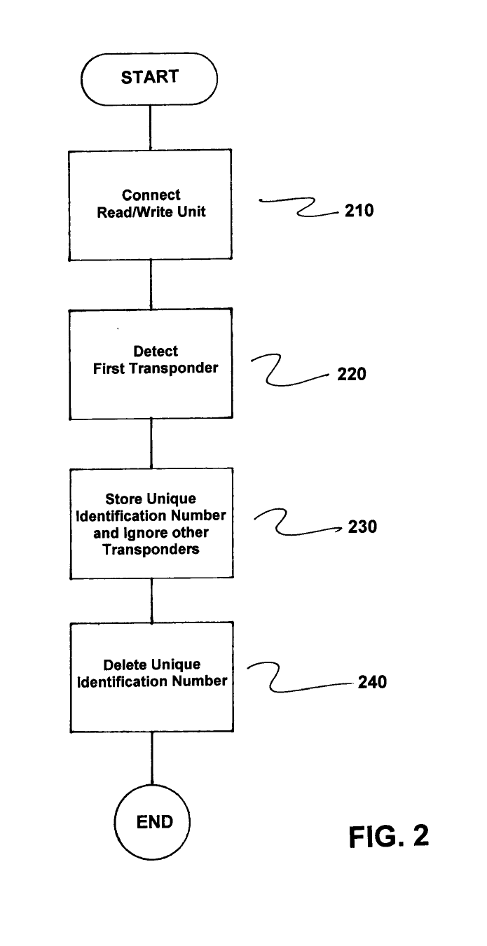

FIG. 2 is a flowchart of a method for operating a read/write unit in a system that includes a plurality of contactlessly readable transponders, where each of the plurality of transponders has a unique identification number. The method comprises connecting the read/write unit to an industrial control device, as indicated in step 210. The first transponder of the plurality of transponders is detected by the read/write unit during a recognition phase, as indicated in step 220.

The unique identification number of the detected first transponder is stored in a holding register of the read/write unit at the start of a holding phase, and other transponders of the plurality of transponders are ignored by the read/write unit during the holding phase, as indicated in step 230. The unique identification number of the detected first transponder of the plurality of transponders is then deleted from the holding register to terminate the holding phase, as indicated in step 240.

While there have shown and described and pointed out fundamental novel features of the invention as applied to preferred embodiments thereof, it will be understood that various omissions and substitutions and changes in the form and details of the methods described and devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for operating a read/write unit in a system that includes a plurality of contactlessly readable transponders, each of the plurality of transponders having a unique identification number, comprising the steps of:
connecting the read/write unit to an industrial control device;
detecting by the read/write unit, during a recognition phase, a first transponder of the plurality of transponders;
storing, at a start of a holding phase, the unique identification number of the detected first transponder in a holding register of the read/write unit, and ignoring by the read/write unit other transponders of the plurality of transponders during the holding phase; and
deleting from the holding register the unique identification number of the detected first transponder of the plurality of transponders to terminate the holding phase.

2. The method as claimed in claim 1, further comprising the step of:
increasing, by the read/write unit during the holding phase, a transmitted power from a minimum to a maximum in a step-by-step progression.

3. The method as claimed in claim 1, further comprising the step of:
terminating, by the read/write unit, the holding phase subsequent to one of receipt of a command from the control device and expiration of a maximum holding period.

4. The method as claimed in claim 1, further comprising the steps of:
managing, in the read/write unit, a blocking list storing entries related selected ones of the unique identification numbers;
comparing each unique identification number of the transponders of the plurality of transponders detected during the recognition phase with the entries stored in the blocking list; and
ignoring, by the read/write unit, each detected transponder for which its unique identification number is determined to coincide with a stored entry.

5. The method as claimed in claim 4, further comprising the step of:
adding the unique identification number to the blocking list following the deletion of the unique identification number from the holding register.

6. The method as claimed in claim 4, wherein the entries in the blocking list are each deleted after the expiration of a blocking period.

7. The method as claimed in claim 5, wherein the entries in the blocking list are each deleted after the expiration of a blocking period.

8. The method as claimed in claim 1, further comprising the steps of:
evaluating, by a filter instance, each transponder of the plurality of transponders detected during the recognition phase; and
determining, by the evaluated filter instance, whether one of a respective transponder of the plurality of transponders is registered in the holding register and the respective transponder is being ignored by the read/write unit.

9. The method as claimed in claim 8, wherein a property of a radio link between the respective transponder and the read/write unit is evaluated as a filter criterion.

10. The method as claimed in claim 9, wherein the evaluated property is a received field strength of a radio signal from the respective transponder.

11. The method as claimed in claim 9, wherein a property to be evaluated is a recognition rate in a plurality of communication cycles of the read/write unit with the respective transponder.

12. The method as claimed in claim 10, wherein a property to be evaluated is a recognition rate in a plurality of communication cycles of the read/write unit with the respective transponder.

13. The method as claimed in claim 9, wherein the filter criterion comprises a property encoded in one of the unique identification number and a useful data field of the respective transponder.

14. The method as claimed in claim 1, wherein starting from a minimum transmitted power, the read/write unit is operated step-by-step with an increasingly higher transmitted power during the recognition phase until one of at least one transponder of the plurality of transponders is detected and a maximum transmitted power is reached.

15. The method as claimed in claim 1, further comprising the step of: transmitting the unique identification number of the detected first transponder to the control device during the holding phase.

16. A read/write unit for use in a system that includes multiple contactlessly readable transponders, wherein the read/write unit is configured to:
connect the read/write unit to an industrial control device;
detect, during a recognition phase, a first transponder of the plurality of transponders;
store, at a start of a holding phase, a unique identification number of the detected first transponder in a holding register of the read/write unit, and ignore other transponders of the plurality of transponders during the holding phase; and
delete the unique identification number of the detected first transponder of the plurality of transponders from the holding register to terminate the holding phase.

17. The read/write unit as claimed claim 16, wherein the read/write unit is further configured to output an error message to the control device, at least one of subsequent to filtering of detected transponders of the plurality of transponders and comparison with a blocking list of the unique identification numbers of the detected transponders, one of no transponder remains to establish a mutual communications relationship with the read/write unit and more than one transponder remains to establish a mutual communications relationship with read/write unit.
